(19) United States
(12) Patent Application Publication
(10) Pub. No.: US 2010/0207522 A1
(43) Pub. Date: Aug. 19, 2010

(54) LAMP

(75) Inventors: Michael Haacke, Aachen (DE); Bernd Prokesch, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/668,901

(22) PCT Filed: Jul. 21, 2008
(86) PCT No.: PCT/IB2008/052917

§ 371 Date: Apr. 16, 2010

(30) Foreign Application Priority Data
Jul. 20, 2007 (EP) 07112827.6

(51) Int. Cl. H01J 61/073

(52) U.S. Cl. 313/567

(57) ABSTRACT

The lamp, particularly the high pressure discharge lamp, comprises a socket (10) made of an insulating material, a burner (12) for emitting light mechanically connected to the socket, and a backlead wire (14) connected to the burner (12), wherein the socket (10) comprises a color with a weighted absorption of <50% and/or a ceramic dielectric (16) arranged around the backlead wire (14) is provided, wherein the ceramic dielectric (16) comprises a color with a weighted absorption of <50%. By using colors for the socket (10) and/or the ceramic dielectric (16) with a low absorption it is possible to increase the luminous flux of the lamp significantly without increasing the power of the lamp.

### FIELD OF THE INVENTION

The invention relates to the field of lamps, and more specifically to motor vehicle lamps, like high pressure discharge lamps.

### BACKGROUND OF THE INVENTION

In JP 11102638 a high pressure discharge lamp is disclosed which can be used as motor vehicle headlight. The high pressure discharge lamp comprises a burner for emitting light which is connected to a socket made of plastic material. Furthermore, the lamp comprises a backlead wire which is connected to the burner. Since inconvenient reflection worsens the luminous-intensity-distribution property of the light emitted from the socket dark colors are selected for the socket.

There is a permanent need to increase the efficiency of lamps, particularly of high pressure discharge lamps, by a cost effective manner.

### SUMMARY OF THE INVENTION

It is an object of the invention to provide a lamp, particularly a high pressure discharge lamp, comprising an increased integral lumen output without varying the parameters of the burner.

The lamp, particularly the high pressure discharge lamp, according to the invention comprises a socket made of an insulating material, a burner for emitting light mechanically connected to the socket, and a backlead wire connected to the burner wherein the socket comprises a color with a weighted absorption of ≦50%, preferably ≦30% and most preferred ≦15% and/or a ceramic dielectric arranged around the backlead wire is provided wherein the ceramic dielectric comprises a color with a weighted absorption of ≦50%, preferably ≦30% and most preferred ≦15%.

The socket of the lamp is made of an insulating material, preferably a plastic material, for instance PPS (polyphenylene sulfide, (SC₆H₄)ₙ). By using a color for the socket which comprises a weighted absorption of ≦50%, preferably ≦30% and most preferred ≦15% the efficiency, especially the integrated lumen output, of the lamp is increased since energy of the lamp is getting lost as few as possible. Particularly, the weighted absorption of the color of the socket is ≧10%. The weighted absorption A is defined as A=1−R, wherein R is the weighted reflectivity. The weighted reflectivity R and the weighted absorption A are calculated as R=∫R(λ)*V(λ)dλ/∫V(λ)dλ and A=∫A(λ)*V(λ)dλ/∫V(λ)dλ, wherein V is the sensitivity of the human eye in dependency of the wavelength λ. Preferably, bright colors may be chosen for the socket to achieve a very low weighted absorption. Theses colors may be for example green, light blue or beige. Since the absorption effect of the socket is reduced by using brighter colors the reflectance effect of the socket is increased. Thus, it is possible to increase the integral lumen output without significantly increasing the danger to blind someone by too high glare values of the light beam. Surprisingly, it was find out that it is advantageously to use bright colors instead of dark colors for the socket to get a light intensity as high as possible without varying the parameters of the burner.

Moreover, it is possible to arrange a ceramic dielectric around the backlead wire wherein the ceramic dielectric comprises a color with a weighted absorption A of ≦50%, preferably ≦30% and most preferred ≦15%. Particularly, the weighted absorption of the color of the ceramic dielectric is ≧5%. The ceramic dielectric provides an isolation of the backlead wire from the burner. Preferably the ceramic dielectric is formed as a tube which is arranged around the backlead wire. By using a color for the ceramic dielectric with a weighted absorption as low as possible the efficiency, especially the integral lumen output, of the lamp is increased since as few as possible energy of the lamp is getting lost. To achieve a very low weighted absorption preferably bright colors like green, light blue or beige are chosen for the ceramic dielectric. Since the absorption effect of the ceramic dielectric is reduced by using brighter colors the reflectance effect of the ceramic dielectric is increased. Thus, the integral lumen output of the lamp is increased.

If the socket together with the ceramic dielectric comprise a color with a weighted absorption as low as possible the efficiency, especially the integral lumen output, of the lamp is increased even more.

By using colors for the socket and/or the ceramic dielectric with a low weighted absorption it is possible to increase the luminous flux of the lamp significantly without increasing the power of the lamp or changing the thermal parameters of the lamp, for example by changing the design of the lamp. Moreover, the color point (chromaticity coordinate), color temperature and/or the lamp voltage are not influenced. Thus, with the lamp according to the invention it is possible to increase the efficiency, especially the luminous flux or light intensity, of the lamp in a cost effective manner whereas the durability of the lamp is not changed disadvantageously. Furthermore, by using different bright colors for the socket and/or the ceramic dielectric it is possible to encode the lamp with these colors, for instance depending on the purpose of use or customer requirements.

Preferably, the socket comprises a color, particularly with a high reflectivity, in the range of the eye sensitivity curve with a relative eye sensitivity of 60%-100%, preferably 75%-100%, most preferred 90%-100% and/or the ceramic dielectric comprises a color, particularly with a high reflectivity, in the range of the eye sensitivity curve with a relative eye sensitivity of 60%-100%, preferably 75%-100%, most preferred 90%-100%. The eye sensitivity curve is measured by the relative eye sensitivity depending on the wavelength of the visible light. At the maximum of the eye sensitivity curve where the relative eye sensitivity is especially high the eyes of a human perceive a color as a very bright color so that a lamp with a socket and/or a ceramic dielectric which comprises a color around the maximum of the eye sensitivity curve provides a very good visible light for the motorists and cyclists. Most preferred the color of the socket and/or the ceramic dielectric are in the range of the maximum of the eye sensitivity curve so that a reflection rate as high as possible and/or an absorption rate as low as possible is reached. Thereby, an especially high integral lumen output is attained.

Moreover, in a preferred embodiment the color of the socket and/or the color of the ceramic dielectric comprise a wavelength which is 520 nm-600 nm, preferably 540 nm-580 nm, most preferred 550 nm-570 nm. At a wavelength according to this range, especially at a range of 550 nm-570 nm, the color of the socket and/or the color of the ceramic dielectric have an absorption rate as low as possible so that a high integral lumen output can be reached. Most preferred, a color which lies in the range of the green wavelength is chosen. Preferably the color of the socket and/or the color of the ceramic dielectric have the property to have only low absorption at wavelengths which are evaluated by the eye sensitivity curve.

In a preferred embodiment the chromaticity coordinate of the light emitted by the lamp comprises a X-coordinate in the range of 0.360-0.395, preferably 0.365-0.385, most preferred 0.375-0.380 and a Y-coordinate in the range of 0.360-0.395, preferably 0.370-0.390, most preferred 0.380-0.390 in the CIE 1931 diagram. By these chromaticity coordinates it is achieved that the color point of the emitted light is close to the “black body locus” due to the CIE diagram. Thus, the efficiency of the light is especially high.

Furthermore, in a preferred embodiment the luminous efficacy of the light emitted by the lamp is ≧70 μm/W (lumens per watt), preferably ≧75 μm/W, most preferred ≧95 lm/W. Particularly, luminous efficacy of the light emitted by the lamp is ≦110 lm/W. Luminous efficacy is the ratio of emitted luminous flux to radiant flux. The lamp preferably used may comprise a power of 35 watt.

The color of the socket and/or the color of the ceramic dielectric may be applied by dyeing. The color or for example special color pigments may be mixed with the plastic material of the socket before manufacturing the socket by injection molding, for example. For dyeing the ceramic dielectric the color or special color pigments, for example, may be mixed with the ceramic material before forming the ceramic dielectric. Thus, the colored socket and/or the colored ceramic dielectric may be easily manufactured.

Due to another embodiment the socket and/or the ceramic dielectric comprise a color coating. The coating may easily be applied to the finished formed socket and/or the finished formed ceramic dielectric, whereas it is possible to apply the coating just to the areas of the socket and/or the ceramic dielectric which are in contact with the light of the burner.

The invention further relates to a motor vehicle light arrangement comprising a reflector housing and a lamp connected to the reflector housing. The lamp which particularly may be a headlight, main beam or taillight may be designed as previously described. The reflector housing and the lamp are shaped such that the terminals of the lamp are adapted to come into electrical contact to the reflector housing by turning the lamp after inserting the lamp into the standardized holding recess.

Preferably the reflector housing comprises a color with a weighted absorption of ≦50%, preferably ≦30%, most preferred ≦15%. Particularly, the weighted absorption of the color of the reflector housing is ≧5%. By using a color of the reflector housing which is as bright as possible the absorption is as low as possible. Thus, the efficiency, especially the luminous flux, of the light beam leaving the reflector housing is increased significantly wherein the light intensity measured at the point where the light beam leaves the reflector housing is almost the same as the light intensity measured at the point where the light beam leaves the lamp inside the reflector housing. Hence, it is possible to achieve that hardly of the light efficiency emitted by the lamp is lost. Therefore, especially the inner surfaces of the reflector housing, preferably the inner surfaces in the scope of the light beam, may have a bright color which may be applied by dyeing or by coating.

Preferably the light efficiency of the light measured at the opening of the reflector housing is ≧50 μm/W, preferably ≧60 μm/W, most preferred ≧70 lm/W. Particularly, luminous efficacy of the light measured at the opening of the reflector housing is ≦100 lm/W. At the opening of the reflector housing the light beam of the lamp leaves the reflector housing. With the motor vehicle light arrangement according to the invention it is possible to reach a high light efficiency and therefore a high integral lumen output especially at the opening of the reflector housing.

### BRIEF DESCRIPTION OF THE DRAWINGS

These and other aspects of the invention will be apparent from and elucidated with reference to the embodiments described hereinafter.

In the drawings:

FIG. 1 is a schematic perspective view of a lamp;

FIG. 2 is the eye sensitivity curve at daylight;

FIG. 3 are boxplots of the luminous flux, lamp voltage and the chromaticity coordinates depending on the color of the ceramic dielectric and

FIG. 4 is a boxplot of the luminous flux depending on the color of the socket and the color of the ceramic dielectric.

### DETAILED DESCRIPTION OF EMBODIMENTS

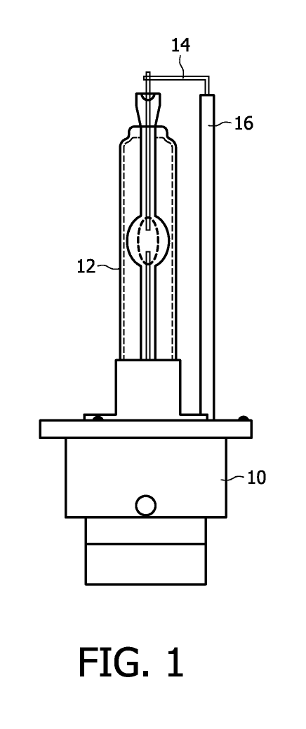

FIG. 1 shows a lamp comprising a socket 10 made of an insulating material, a burner 12 for emitting light which is connected to the socket 10. The lamp comprises a backlead wire 14 which is connected to the burner 12. Around the backlead wire 14 a ceramic dielectric 16 formed as a tube is arranged. The socket 10 and/or the ceramic dielectric 16 comprises a color with a weighted absorption of ≦50%, preferably ≦30% and most preferred ≦15%.

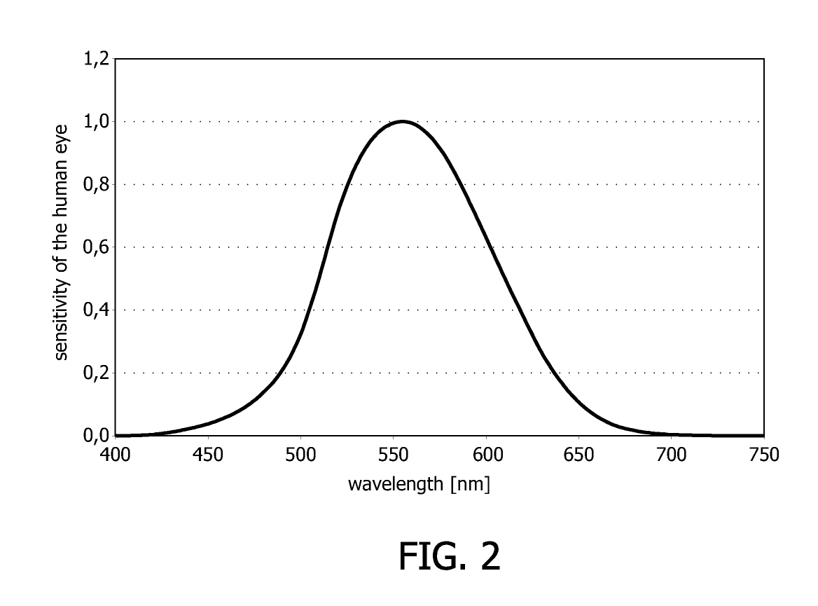

In FIG. 2 the eye sensitivity at daylight is shown as an eye sensitivity curve depending on the relative sensitivity and the wavelength. At the maximum of the eye sensitivity curve where the relative eye sensitivity is especially high the eyes of a human perceive a color as a very bright color so that a lamp with a socket and/or a ceramic dielectric which comprises a color around the maximum of the eye sensitivity curve provides a very good visible light for the motorists and cyclists. Most preferred the color of the socket and/or the ceramic dielectric lies in the range of the maximum of the eye sensitivity curve so that a reflection rate as high as possible and/or an absorption rate as low as possible is reached. Thereby, an especially high integral lumen output is attained. Therefore, the color of the socket and/or the color of the ceramic diametric comprise a wavelength which is 520 nm-600 nm, preferably 540 nm-580 nm, most preferred 550 nm-570 nm so that a relative sensitivity as high as possible according to the eye sensitivity curve is reached.

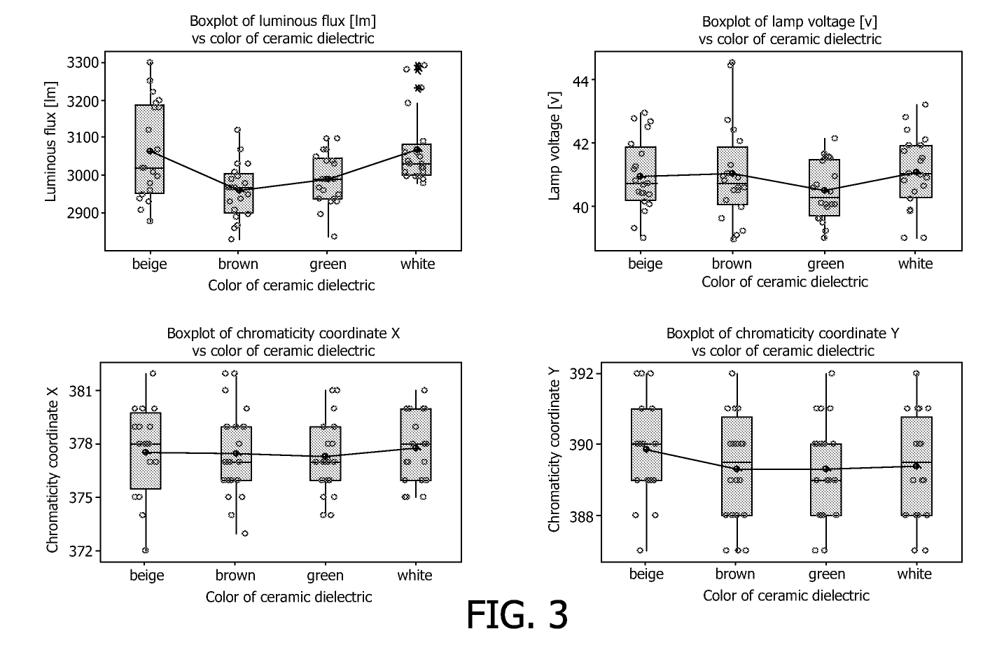

In FIG. 3 different boxplots depending on the color of the ceramic dielectric are shown. The different colors of the ceramic dielectric are beige, brown, green and white. As it can be seen in the first boxplot the brighter the color of the ceramic dielectric the higher is the luminous flux. The luminous flux by using a white or beige colored ceramic dielectric is much better than using a brown colored ceramic dielectric. As it is illustrated in the other boxplots the color of the ceramic dielectric only influences the luminous flux but not the lamp voltage or the chromaticity coordinates. They are almost constant and may only change inessentially.

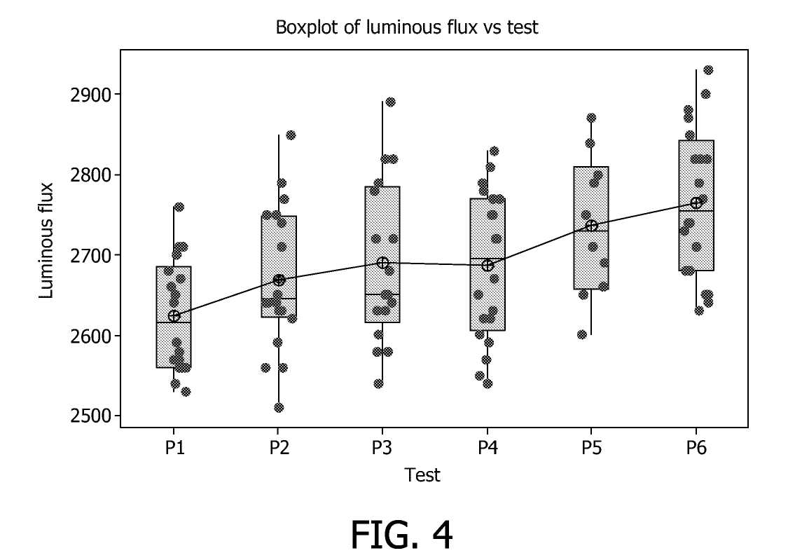

In FIG. 4 a boxplot of the luminous flux depending on different colors for the socket and the ceramic dielectric are shown. The different colors for the socket and the ceramic dielectric are shown in the table below:

| | Color of the socket | Color of the ceramic dielectric |
|---|---|---|
| P1 | brown | brown |
| P2 | brown | blue |
| P3 | brown | beige |
| P4 | green | brown |
| P5 | green | blue |
| P6 | green | beige |

It is clearly shown that the brighter the colors of the socket and the ceramic dielectric are the better the luminous flux is. The best displayed results are achieved by using a green colored socket and a beige colored ceramic dielectric.

While the invention has been illustrated and described in detail in the drawings and foregoing description, such illustration and description are to be considered illustrative or exemplary and not restrictive, the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A high pressure discharge lamp, comprising
a socket comprising an insulating material,
a burner for emitting light mechanically connected to the socket, and
a backlead wire connected to the burner, wherein
the socket comprises a color with a weighted absorption of ≦50%, and/or
a ceramic dielectric is arranged around the backlead wire,
the ceramic dielectric a color with a weighted absorption of ≦50%.

2. The lamp according to claim 1, wherein the socket comprises a color in the range of the eye sensitivity curve with a relative eye sensitivity of 60%-100%.

3. The lamp according to claim 1, wherein the color of the socket and/or the color of the ceramic dielectric comprise a wavelength λ, in the range of 520 nm-600 nm.

4. The lamp according to claim 1, wherein the chromaticity coordinate of the light emitted by the lamp and a Y-coordinate are in the range of 0.360-0.395 in the CIE 1931 diagram.

5. The lamp according to claim 1, wherein the luminous efficacy of the light emitted by the lamp is 70 lm/W.

6. The lamp according to claim 1, wherein the color of the socket and/or the color of the ceramic dielectric is applied by dyeing.

7. The lamp according to claim 1, wherein the socket and/or the ceramic dielectric comprise a color coating.

8-10. (canceled)

11. The lamp according to claim 1, wherein the ceramic dielectric comprises a color in the range of the eye sensitivity curve with a relative eye sensitivity of 60%-100%.
